(19) United States
(12) Patent Application Publication
(10) Pub. No.: US 2007/0280622 A1
(43) Pub. Date: Dec. 6, 2007

(54) FLUORESCENT LIGHT SOURCE HAVING LIGHT RECYCLING MEANS

(75) Inventor: Todd S. Rutherford, Cincinnati, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/421,787

(22) Filed: Jun. 2, 2006

(51) Int. Cl. G02B 6/00

(52) U.S. Cl. 385/142

(57) ABSTRACT

A light guide and a projection system incorporating same are disclosed. The light guide includes a material that is capable of emitting light of a second wavelength when illuminated with light of a first wavelength where the first wavelength is different from the second wavelength. The light guide further includes an exit face that has a first portion that is reflective at the second wavelength and a second portion that is transmissive at the second wavelength. When the light guide is illuminated with light of the first wavelength, the material converts at least a portion of the light of the first wavelength into light of the second wavelength. The majority of the light of the second wavelength that exits the second portion of the exit face is totally internally reflected by the light guide.

### FIELD OF THE INVENTION

This invention generally relates to light sources and projection systems incorporating the same. The invention is particularly applicable to fluorescent volume light sources that are capable of light recycling.

### BACKGROUND

Projection systems generally use one or more light sources as part of an illumination system for illuminating an image forming device or devices in the projection system. It is often desirable that an image projected by a projection system have high brightness. The brightness of the projected image is typically limited by the brightness of the light sources in the illumination system. Exemplary light sources include mercury arc light sources, fluorescent light sources, and light emitting diode (LED) light sources. LED light sources are generally not acceptable because the brightness of currently available LEDs is often too low.

### SUMMARY OF THE INVENTION

Generally, the present invention relates to illumination systems. The present invention also relates to illumination systems employed in projection systems.

In one embodiment of the invention, a light guide includes a material that is capable of emitting light of a second wavelength when illuminated with light of a first wavelength where the first wavelength is different from the second wavelength. The light guide further includes an exit face that has a first portion that is reflective at the second wavelength and a second portion that is transmissive at the second wavelength. When the light guide is illuminated with light of the first wavelength, the material converts at least a portion of the light of the first wavelength into light of the second wavelength. The majority of the light of the second wavelength that exits the second portion of the exit face is totally internally reflected by the light guide.

In another embodiment of the invention, a light guide includes a material that is capable of emitting light of a second wavelength when illuminated by light of a first wavelength. The first wavelength is different from the second wavelength. The light guide further includes an exterior surface that includes an optically transmissive exit aperture. The exterior surface has an optically transmissive portion that has a first area. The exterior surface further has an optically reflective portion that has a second area. The first area is substantially larger than the second area. Illumination of the transmissive portion of the exterior surface with light of the first wavelength causes the material to convert at least a portion of the light of the first wavelength into light of the second wavelength. At least a portion of the light of the second wavelength exits the light guide from the exit aperture.

### BRIEF DESCRIPTION OF DRAWINGS

The invention may be more completely understood and appreciated in consideration of the following detailed description of various embodiments of the invention in connection with the accompanying drawings, in which:

FIG. 1 shows a schematic three-dimensional view of a light guide in accordance with one embodiment of the invention;

FIGS. 2A-2E show exemplary schematic end-views of light guides of the invention;

FIG. 3 shows a schematic side-view of a light source assembly in accordance with one embodiment of the invention;

FIG. 3A shows a schematic side-view of a portion of a light source assembly in accordance with one embodiment of the invention;

FIG. 4 shows a schematic three-dimensional view of a light source assembly in accordance with another embodiment of the invention;

FIG. 5 shows a schematic side-view of a light source assembly in accordance with another embodiment of the invention; and

FIG. 6 shows a schematic side-view of a projection display system in accordance with one embodiment of the invention.

### DETAILED DESCRIPTION

The present invention generally relates to illumination systems and projection systems incorporating same. The invention is particularly applicable to illumination systems where it is desirable to provide illumination with high light brightness. An example of such a system may be found in commonly-owned U.S. patent application Ser. No. 11/092,284, “Fluorescent Volume Light Source.”

In the specification, a same reference numeral used in multiple figures refers to the same or similar elements having the same or similar properties and functionalities.

The present invention describes an illumination system that includes a light guide where the light guide is capable of converting a pump light into a converted light of a desired wavelength where the brightness of the converted light is increased by providing means for recycling the converted light within the light guide before the converted light exits the light guide from a reduced exit aperture.

An advantage of the present invention is that the light guide can have a large cross-sectional dimension and/or area for improving efficient absorption of the pump light while at the same time maintaining or increasing brightness of the converted light that exits the illumination system.

The brightness of a light source is typically measured as the ratio of the optical power of the light source (that is, the amount of light extracted from the light source) divided by the light source étendue. The étendue is generally a function of the product of the light emitting area of the light source and the solid angle of the emitted light beam. In a projection system, a conventional component, such as a lens or a light valve, cannot decrease the étendue of a light beam it encounters. These components, however, may cause the étendue to increase. Therefore, since it is typically desirable to have as bright a light beam as possible in projection systems, it is desirable for the light source to generate a light beam with a small étendue. An additional advantage of the current invention is that it provides a low cost light source that can generate light with high efficiency. One particular desirable wavelength of light useful in projection systems is green light (for example, light having a wavelength of about 550 nanometers). Currently available green light emitting diode (LED) light sources lack sufficient brightness or are prohibitively expensive. The current invention provides an efficient low cost system for converting light from commonly available blue LEDs into green light.

Furthermore, the small étendue light beam generated by the inventive light source enables the use of smaller system components, reducing the size of the system as well as providing lower overall system cost.

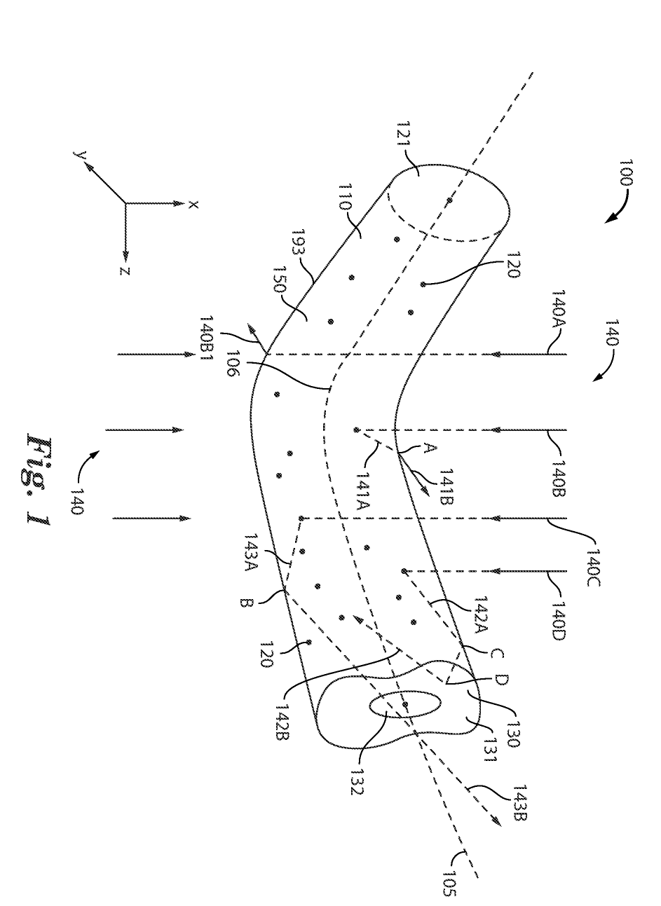

FIG. 1 illustrates a three-dimensional schematic of a light guide 100 in accordance with one embodiment of the invention. Light guide 100 includes an end face 121, an exit face 130, and an optical body 110 disposed between end face 121 and exit face 130. Optical body 110 contains a converting material 120 that is capable of emitting light of a second wavelength λ₂ when illuminated by light of a first wavelength λ₁ where λ₂ is different from

Wavelengths λ₁ and λ₂ can be any wavelengths that may be of interest in an application. For example, wavelengths λ₁ and λ₂ can be in the ultraviolet (UV) and visible regions of the electromagnetic spectrum, respectively. As another example, wavelengths λ₁ and λ₂ can both be in the visible regions of the electromagnetic spectrum. For example, λ₁ can be in the blue region and λ₂ can be in the green region of the spectrum. As another example, λ₁ can be in the blue region and λ₂ can be in the red region of the spectrum.

According to one embodiment of the invention, when light guide 100 is illuminated with light 140 of wavelength λ₁, the converting material 120 converts at least a portion of the light of wavelength λ₁ into light of wavelength λ₂.

Converting material 120 can be considered a dopant in a host material that forms optical body 110. Converting material 120 can, for example, be dispersed or distributed uniformly or non-uniformly within optical body 110 resulting in a doping density “d” of converting material 120 within optical body 110. In some systems, optical body 110 may be formed of the converting material 120 itself. Converting material 120 can, for example, be a fluorescent material. In such a case, the fluorescent material is capable of absorbing light at wavelength λ₁ and fluorescently emitting light at wavelength λ₂ where the emitted light is often referred to as the fluorescent light. The fluorescent light is typically emitted isotropically by the fluorescent material. The emitted light at wavelength λ₂ may be associated with a quantum mechanically allowed transition. In some cases, the emitted light at wavelength λ₂ may be associated with a quantum mechanically disallowed transition, in which case the process is commonly referred to as phosphorescence.

Converting material 120 can be a type of fluorescent material that absorbs only a single photon at λ₁ before emitting the fluorescent light at λ₂, in which case λ₂ may be a longer wavelength than λ₁. In some systems, converting material 120 can be a type of fluorescent material that absorbs more than one photon at λ₁ before emitting the fluorescent light, in which case λ₂ may be a shorter wavelength than λ₁. Such a phenomenon is commonly referred to as upconversion fluorescence.

Converting material 120 can be a type of fluorescent system in which light of wavelength λ₁ is absorbed by a first absorbing species in the converting material and the resulting energy is nonradiatively transferred to a second species in the system followed by an emission of light at λ₂ by the second species. As used herein, the terms fluorescence and fluorescent light refer to systems where light at wavelength λ₁ is absorbed by one species and the energy is re-radiated at wavelength λ₂ by the same or by another species.

Some examples of fluorescent materials that may be doped into optical body 110 include rare-earth ions, transition metal ions, organic dye molecules and phosphors. One suitable class of material for optical body 110 and fluorescent material for converting material 120 includes inorganic crystals doped with rare-earth ions, such as cerium-doped yttrium aluminum garnet (Ce:YAG) or doped with transition metal ions, such as chromium-doped sapphire or titanium-doped sapphire. Rare-earth and transition metal ions may also be doped into glasses.

Another suitable class of material includes a fluorescent dye doped into a polymer body. Many types of fluorescent dyes are available, for example, from Sigma-Aldrich, St. Louis, Mo., and from Exciton Inc., Dayton, Ohio. Common types of fluorescent dye include fluorescein; rhodamines, such as Rhodamine 6G and Rhodamine B; and coumarins such as Coumarin 343 and Coumarin 6. The particular choice of dye depends on the desired wavelength range of the fluorescent light λ₂ and the wavelength of the pump light λ₁. Many types of polymers are suitable as hosts for fluorescent dyes including, but not limited to, polymethylmethacrylate and polyvinylalcohol.

Converting material 120 may include a phosphor. Phosphors include particles of crystalline or ceramic material that include a fluorescent species. A phosphor is often included in a matrix, such as a polymer matrix. In some embodiments, the phosphor may be provided as nanoparticles within the matrix to reduce or eliminate optical scattering.

Other types of fluorescent materials include doped semiconductor materials, for example doped II-VI semiconductor materials such as zinc selenide and zinc sulphide.

One example of an upconversion fluorescent material is a thulium-doped silicate glass, described in greater detail in co-owned U.S. Patent Publication No. 2004/0037538 A1. In this material, two, three or even four pump light photons are absorbed in a thulium ion (Tm³⁺) to excite the ion to different excited states that subsequently fluoresce. The particular selection of fluorescent material depends on the desired fluorescent wavelength λ₂ and the wavelength λ₁ of light 140.

Converting material 120 can include a photoluminescent material, such as a fluorescent material described above or a phosphorescent material. A phosphorescent material can continue to emit light at λ₂ even after the excitation source at λ₁ is extinguished. In general, converting material 120 can be any material that is capable of converting light of wavelength λ₁ to light of wavelength λ₂.

Light guide 100 further includes walls 193 joining end face 121 and exit face 130. According to one embodiment of the invention, at least portions of walls 193 are optically transmissive at wavelength λ₁. According to another embodiment of the invention, the entirety of walls 193 are optically transmissive at wavelengths λ₁ and λ₂.

End face or exit face 130 is designed to transmit light of second wavelength λ₂. Exit face 130 includes an optically reflective portion 131 and an optically transmissive portion 132. Optically reflective portion 131 is capable of reflecting essentially all or a substantial portion of light of second wavelength λ₂. In some applications, reflective portion 131 is at least 50% reflective at wavelength λ₂. In some other applications, reflective portion 131 is at least 80% reflective at wavelength λ₂. In some other applications, reflective portion 131 is at least 90% reflective at wavelength λ₂. In some other applications, reflective portion 131 is at least 95% reflective at wavelength λ₂. In yet some other applications, reflective portion 131 is at least 98% reflective at wavelength λ₂.

Reflective portion 131 can be made of any material or have any construction that may result in portion 131 being highly reflective at wavelength λ₂. Reflective portion 131 can, for example, be a metal coating where the metal can, for example, be silver, aluminum, gold, or a combination thereof, or any other metal or combination of metals that is capable of providing high reflectance at λ₂. As another example, reflective portion 131 can be a multilayer dielectric coating that reflects light, for example, by optical interference.

As still another example, reflective portion 131 can be a reflective material laminated, or otherwise attached, or even placed in proximity to exit face 130. For example, reflective portion 131 can be a polymeric multilayer optical film (MOF) that includes alternating layers where the alternating layers have different indices of refraction, and where the MOF reflects light by optical interference. The term optical interference, as used herein, means that an incoherent analysis is generally not adequate to sufficiently predict or describe all the reflective properties of a layer that reflects light by optical interference in a desired region of the spectrum. In one embodiment of the invention, each of the alternating layers in the MOF reflects light by optical interference. The multilayer optical film can, for example, have high reflectance in a wavelength region of the spectrum that includes λ₂. Multilayer optical films have been discussed in, for example, U.S. Pat. Nos. 3,610,729; 4,446,305; 4,540,623; 5,448,404; and 5,882,774.

Optically transmissive portion 132 is capable of transmitting essentially all or a substantial portion of light of second wavelength λ₂. In some applications, transmissive portion 132 is at least 50% transmissive at wavelength λ₂ where the transmissivity does not include losses due to surface reflections, sometimes referred to as Fresnel reflection. In some other applications, transmissive portion 132 is at least 80% transmissive at wavelength λ₂. In some other applications, transmissive portion 132 is at least 90% transmissive at wavelength λ₂. In some other applications, transmissive portion 132 is at least 95% transmissive at wavelength λ₂. In yet some other applications, transmissive portion 132 is at least 98% transmissive at wavelength λ₂. In some applications, at least one of portions 131 and 132 can be substantially reflective or transmissive at wavelength λ₁. For example, reflective portion 131 can be substantially reflective at both wavelengths λ₁ and λ₂, or it can be substantially reflective at λ₂ and substantially transmissive at λ₁. As another example, transmissive portion 132 can be substantially transmissive at both wavelengths λ₁ and λ₂, or it can be substantially transmissive at λ₂ and substantially reflective at λ₁.

Light rays from light 140 can be incident on light guide 100 from different directions. For example, light 140 can illuminate optical body from above (along negative x-direction) and below (along positive x-direction). In general, light 140 can illuminate optical body 110 from any direction, including one or more directions, that may be desirable or advantageous in an application.

Light rays in light 140 that are incident on light optical body 110 can interact with optical body 110 in different ways. For example, light ray 140A from light 140 can be transmitted by optical body 110 as ray 140B1 with no, little, or some absorption by converting material 120. According to one embodiment of the invention, the doping density of converting material 120 in optical body 110 and/or the dimensions of the optical body in the direction of illuminating light 140 (e.g., the dimension along the x-axis) is sufficiently great to result in essentially complete or substantial absorption of light 140 by converting material 120 within the light guide.

As another example, light ray 140B from light 140 can be absorbed by converting material 120 and be emitted by the converting material as light ray 141A with wavelength λ₂, and exit light guide 100 as ray 141B after being refracted at location “A” on exterior surface 150 of light guide 100.

As another example, light ray 140C of light 140 can be absorbed by converting material 120 and be emitted by the converting material as light ray 143A with wavelength λ₂, and exit light guide 100 through transmissive portion 132 as light ray 143B after being totally internally reflected at location “B” on exterior surface 150.

As yet another example, light ray 140D of light 140 can be absorbed by converting material 120 and be emitted by the converting material as light ray 142A with wavelength λ₂, and be reflected at location “D” by reflective portion 131 as light ray 142B after being totally internally reflected at location “C” on exterior surface 150. According to one embodiment of the invention, at least some rays, such as ray 142B, that are reflected by reflective portion 131 are recycled within light guide 100 and eventually exit the light guide through transmissive portion 132.

According to one embodiment of the invention, the majority of light rays of wavelength λ₂ that are emitted by converting material 120 and which exit the optical body through transmissive portion 132, undergo at least one total internal reflection by light guide 100 and, in particular, by exterior surface 150.

An advantage of total internal reflection is reduced or no loss upon reflection, which can result in increased brightness of light that exits light guide 100 from transmissive portion 132.

Exterior surface 150 of light guide 100 covers the entire external surface of the light guide including end face 121 and exit face 130. According to one embodiment of the invention, exterior surface 150 includes some portions that are optically transmissive and other portions that are optically reflective. For example, end face 121 may be optically reflective, or the entire surface of walls 193 of light guide 100 may be optically transmissive. As another example, transmissive portion 132 is part of exterior surface 150 and is optically transmissive. As yet another example, reflective portion 131 is part of exterior surface 150 and is optically reflective.

Transmissive portion 132 of exterior surface 150 provides an exit aperture for light guide 100 where the exit aperture is designed to transmit at least a substantial portion of light of wavelength λ₂ that is generated within the light guide.

According to one embodiment of the invention, exterior surface 150 of light guide 100 has an optically transmissive portion having a first area and an optically reflective portion having a second area, where the first area is substantially larger than the second area. In some applications, the first area is at least 5 times the second area. In some other applications, the first area is at least 10 times the second area. In some other applications, the first area is at least 20 times the second area. In some other applications, the first area is at least 50 times the second area. In yet some other applications, the first area is at least 75 times the second area. In yet some other applications, the first area is at least 100 times the second area. In yet some other applications, the first area is at least 500 times the second area.

According to one embodiment of the invention, light guide 100 is centered on an optical axis 105 where the optical axis can be straight, curved, or folded at one or more locations along the optical axis such as at location 106.

Light guide 100 can have any shape cross-section along a given direction. For example, a cross-section of light guide 100 in a plane perpendicular to optical axis 105 can be different, for example different in size or shape, at different locations along the optical axis. Furthermore, the cross-section of light guide 100 in a plane perpendicular to optical axis 105 can have any shape having a regular or irregular perimeter. For example, the perimeter of a cross-section of light guide 100 may be a circle, an ellipse, or a polygon, such as a quadrilateral, a rhombus, a parallelogram, a trapezoid, a rectangle, a square, or a triangle, or any other shape that may be desirable in an application.

The shape of exit face 130 can be different than the shape of a cross-section of light guide 100 at a different location along optical axis 105 in a plane that is parallel to exit face 130. For example, exit face 130 may be a rectangle while a cross-section at a different location along the optical axis may be a square.

Light guide 100 may be tapered along optical axis 105. An example of a tapered optical body is described in U.S. Pat. No. 6,332,688.

Transmissive portion 132 can have any shape that may be desirable in an application. Examples include a circle, an ellipse, or a polygon, such as a quadrilateral, a rhombus, a parallelogram, a trapezoid, a rectangle, a square, or a triangle. In some applications, such as in a projection system, transmissive portion 132 is imaged, using imaging optics, onto an image forming device, such as a liquid crystal display (LCD). In such case, it may be advantageous to design transmissive portion 132 so that its shape is the same as the shape of the active area of the image forming device. For example, both the transmissive portion and the image forming device can be rectangular.

Exit face 130 can be perpendicular to optical axis 105, although in some applications, exit face 130 may form an angle other than 90 degrees with optical axis 105. Furthermore, exit face 130 may be planar (that is, flat) or non-planar. For example, exit face 130 can be curved, in which case transmissive portion 132 may have positive or negative optical power.

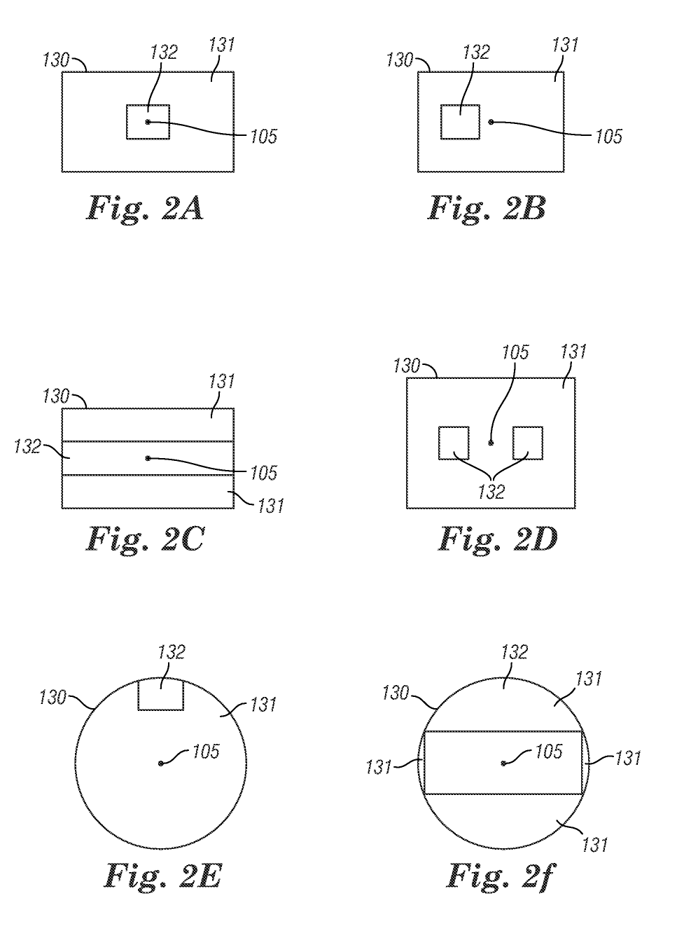

In the exemplary embodiment shown in FIG. 1, exit face 130 includes a transmissive portion 132 surrounded by a single reflective portion. In general, exit face 130 can have one or more optically transmissive portions and one or more optically reflective portions. Five such examples are shown in FIGS. 2A-2E, where each figure is an end-view of light guide 100 schematically showing exit face 130. In particular, FIG. 2A shows a single rectangular transmissive portion 132 surrounded on all sides by a single rectangular reflective portion 131 where both portions 131 and 132 are centered on optical axis 105 and where the transmissive portion is also centered within the reflective portion.

FIG. 2B shows a single square transmissive portion 132 surrounded on all sides by a single rectangular reflective portion 131 where portion 131, but not 132, is centered on optical axis 105. FIG. 2C shows a single rectangular transmissive portion 132 that extends across the entire exit face 130 along one direction (horizontal in FIG. 2C) and is symmetrically positioned between two reflective portions 131. The two reflective portions 131 are symmetrically positioned relative to optical axis 105 and transmissive portion 132 is centered on optical axis 105. Transmissive portion 132 is partially surrounded by the reflective portions.

FIG. 2D shows two square transmissive portions 132 surrounded on all sides by a single square reflective portion 131 where portion 131 is centered on optical axis 105, the two transmissive portions are symmetrically positioned within the reflective portion, and the two transmissive portions are symmetrically positioned relative to optical axis 105.

As yet another example, FIG. 2E shows a single truncated rectangular transmissive portion 132 positioned next to the perimeter of a circular exit face 130. The transmissive portion 132 is partially surrounded by a single reflective portion 131 which is centered on optical axis 105. Transmissive portion 132 is not centered on optical axis 105.

As yet another example, FIG. 2F shows a circular exit face 130 having a single rectangular transmissive portion 132 centered on optical axis 105 and symmetrically positioned between four reflective portions 131. The four reflective portions 131 are symmetrically positioned relative to optical axis 105.

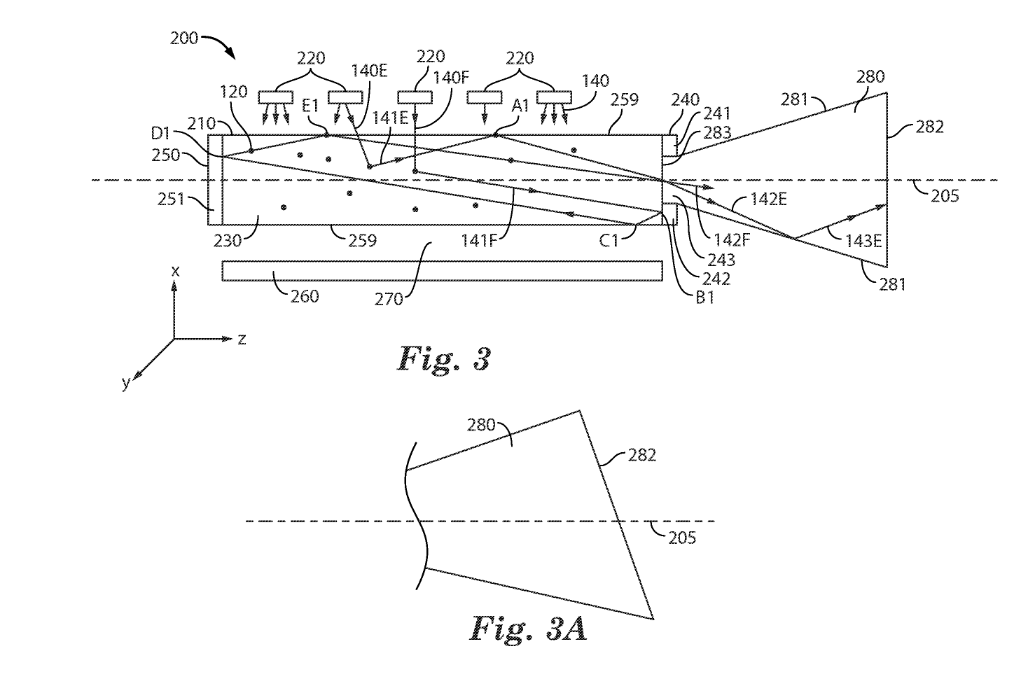

FIG. 3 illustrates a schematic side-view of a light source assembly 200 in accordance with one embodiment of the invention. Light source assembly 200 includes a light guide 210 that is generally centered on an optical axis 205. In the exemplary embodiment shown in FIG. 3, light guide 210 is straight and directed along the z-axis. In general, light guide 210 can have any shape that may be desirable in an application. For example, light guide 210 may be curved, nonlinear, or piece-wise linear. In some applications, light guide 210 may be folded at one or more locations along optical axis 205.

Light guide 210 includes a first end face 250, a second end face or exit face 240, and an optical rod 230 that includes converting material 120 and joins end faces 240 and 250. End face 250 includes a reflective film 251 that essentially covers the entire end face 250.

Reflective film 251 is capable of reflecting essentially all or a substantial portion of light at wavelength λ₂. In some applications, reflective film 251 is at least 50% reflective at wavelength λ₂. In some other applications, reflective film 251 is at least 80% reflective at wavelength λ₂. In some other applications, reflective film 251 is at least 90% reflective at wavelength λ₂. In some other applications, reflective film 251 is at least 95% reflective at wavelength λ₂. In yet some other applications, reflective film 251 is at least 98% reflective at wavelength λ₂.

End face or exit face 240 includes one or more optically reflective portions, such as reflective portions 241 and 242, and one or more optically transmissive portions, such as transmissive portion 243.

Light source assembly 200 further includes one or more light sources 220 that are capable of generating light 140 at wavelength λ₁ for illuminating optical rod 230. Similar to the discussion in reference to FIG. 1, light rays in light 140 that are incident on optical rod 230 can interact with optical rod 230 in different ways. For example, light ray 140E from light 140 can be absorbed by converting material 120 and be emitted by the converting material as light ray 141E with wavelength λ₂, and exit light guide 210 through transmissive portion 243 as ray 142E after being totally internally reflected at location “A1” on exterior surface 259 of light guide 210.

As another example, light ray 140F of light 140 can be absorbed by converting material 120 and be emitted by the converting material as light ray 141F with wavelength λ₂, and exit light guide 210 through transmissive portion 243 as ray 142F after being reflected by reflective portion 242 at location “B1,” totally internally reflected by exterior surface 259 at location “C1,” reflected by reflective film 251 at location “D1,” and totally internally reflected at location “E1” on exterior surface 259.

Light sources 220 can be any type light source capable of emitting light at wavelength λ₁. Furthermore, light sources 220 can include coherent or incoherent light sources. For example, light sources 220 can include an arc lamp such as a mercury arc lamp, an incandescent lamp, a fluorescent lamp, a light emitting diode (LED), or a laser. According to one embodiment of the invention, light sources 220 are LED light sources.

Reflective portions 241 and 242 reduce the size of the optically transmissive portion of exit face 240 to a smaller transmissive portion 243, thereby increasing brightness of light at wavelength λ₂ that exits the light guide from transmissive portion 243. Furthermore, reflective portions 241 and 242 permit the use of a light guide 210 with a large cross-section (e.g., in the xy-plane), thereby providing for efficient absorption of light 140 by converting material 120. Additionally, reflective portions 241 and 242 and reflective film 251 provide a recycling cavity so that rays at wavelength λ₂ that do not exit light guide 210 from transmissive portion 243 are recycled within the light guide until all or a substantial portion of the recycled rays eventually exit the light guide from transmissive portion 243.

According to one embodiment of the invention, the majority of light rays of wavelength λ₂ that are emitted by converting material 120 and which exit light guide 210 through transmissive portion 243, undergo one or more total internal reflections by exterior surface 259 before exiting the light guide.

An advantage of total internal reflection is reduced or no reflection loss which can result in increased brightness of light that exits light guide 210 from transmissive portion 243.

Light source assembly 200 further includes a reflector 260 designed to reflect light 140 that is transmitted by optical rod 230 back towards the optical rod for absorption by converting material 120 and conversion to light of wavelength λ₂. According to one embodiment of the invention, reflector 260 is separated from optical rod 230 by a gap 270 where the index of refraction, n₂, of the gap is less than the index of refraction of the optical rod, n₁, so that exterior surface 259 remains capable of reflecting light that is inside the optical rod by total internal reflection. Reflector 260 can be similar to reflective film 251. Furthermore, reflector 260 can be a diffuse or specular reflector.

Light source assembly 200 further includes a light extractor 280 with an output face 282 and an input face 283 that is optically coupled to transmissive portion 243 of light guide 210. Light extractor 280 is centered on and tapered along optical axis 205. In the exemplary embodiment shown in FIG. 3, the cross-sectional area of light extractor 280 increases along the z-axis, resulting in the area of output face 282 being larger than the area of input face 283. In some applications, light extractor 280 can be tapered so that its cross-sectional area in a plane perpendicular to optical axis 205 (xy-plane) decreases along the optical axis resulting in the area of output face 282 being smaller than the area of input face 283. Walls 281 of light extractor 280 may be straight, as illustrated in FIG. 3, may be curved, or may have any shape that may be desirable in an application. A cross-sectional dimension of light extractor 280 in the xy-plane may change along the optical axis. For example, FIG. 3 shows an increase in the light extractor's x-dimension along the optical axis.

Some light rays at wavelength λ₂ that exit light guide 210 and enter light extractor 280 from input face 283 of the light extractor may reach output face 282 without being reflected at walls 281 of the light extractor. Some other light rays, however, may undergo one or more reflections at walls 281 before reaching output face 282. For example, light ray 142E undergoes a reflection at wall 281 and reaches output face 282 as light ray 143E. Reflection of light rays at wavelength λ₂ at walls 281 tends to direct the light rays along the optical axis, and so the angular spread of the light at output face 282 of the light extractor is generally less than the angular spread of the light that enters the light extractor from light guide 210 through input face 283.

In the exemplary embodiment shown in FIG. 3, output face 282 is planar. In general, output surface 282 may have any shape that may be desirable in an application, such as a curved surface where the curvature may be different along different directions.

Light rays at wavelength λ₂ that enter light extractor 280 may be redirected by walls 281 by total internal reflection. In some applications, all or portions of walls 281 may be provided with a reflective coating, for example a metal coating or an inorganic dielectric stack or a polymer MOF reflective film, for reflecting light rays that enter light extractor 280.

Light extractor 280 may or may not include converting material 120. In some applications, light extractor 280 may include converting material 120 so that any light 140 that may enter the light extractor can be absorbed and converted to light of wavelength λ₂. Where light extractor 280 includes converting material 120, the light extractor may also be directly illuminated with light sources 220 by, for example, placing one or more light sources 220 proximate walls 281 (not explicitly shown in FIG. 3).

Light extractor 280 may be a component separate from light guide 210, as illustrated in FIG. 3, in which case, transmissive portion 243 and input face 283 may be optically coupled by, for example, adhering the two by an optical adhesive or by simply placing the two in close proximity to one another. According to one embodiment of the invention, light extractor 280 is an integral part of light guide 210. For example, light guide 210 and light extractor 280 may be molded from a single piece of material, such as glass or a polymeric material, in which case, the light extractor may contain converting material 120. In such a case, both the light guide and the light extractor may be directly illuminated with light sources 220, although in some applications, it may be sufficient or desirable to only illuminate the light guide with light sources 220.

Where light guide 210 is formed integrally with light extractor 280, the transmissive portion 243 may be considered to be the optically transmissive portion of the integrated light guide/extractor in the plane that includes reflective portions 241 and 242.

In general, exit face 240 can have one or more optically transmissive portions and one or more optically reflective portions. Examples include embodiments illustrated in FIGS. 2A-2E.

Output face 282 of light extractor 280 may be perpendicular to optical axis 205, as illustrated in FIG. 3, or may be tilted as, for example, schematically illustrated in FIG. 3A and described in U.S. patent application Ser. No. 10/744,994. A tilted output face 282 may be useful, for example, where in a projection system the output face is imaged by an image relay system onto a tilted target, where the target can, for example, be capable of forming an image. One example of a tilted target is a digital micro-mirror device (DMD), an example of which is supplied by Texas Instruments, Plano, Tex., as a DLP™ imager. A DMD has many mirrors positioned in a plane, each mirror being individually addressable to tilt between two positions, typically referred to as the “on” and “off” positions.

Reflective film 251 can be made of any material or have any construction that may result in high reflectance at wavelength λ₂. Reflective film 251 can, for example, be a metal coating where the metal can, for example, be silver, aluminum, gold, or a combination thereof, or any other metal or combination of metals that is capable of providing high reflectance at λ₂. As another example, reflective film 251 can be a multilayer dielectric coating that reflects light, for example, by optical interference.

As still another example, reflective film 251 can be a reflective material laminated, or otherwise attached, or even placed in proximity to end face 250. For example, reflective film 251 can be a polymeric multilayer optical film (MOF).

According to one embodiment of the invention, reflective film 251 essentially covers the entire end face 250. In some applications, however, reflective film 251 may cover only a portion of end face 250 leaving some optically transmissive portions on end face 250.

Exterior surface 259 of light guide 210 covers the entire exterior of light guide 210 and has a total first area W11. Exterior surface 259 includes an optically reflective portion that includes, for example, end face 250 and reflective portions 241 and 242, and which has a total second area W22. Exterior surface 259 further includes an optically transmissive portion that includes, for example, transmissive portion 243, and which has a total third area W33 where W11=W22+W33. According to one embodiment of the invention, W33 is substantially larger than W22.

In some applications, W33 is at least 5 times W22. In some other applications, W33 is at least 10 times W22. In some other applications, W33 is at least 20 times W22. In some other applications, W33 is at least 50 times W22. In some other applications, W33 is at least 75 times W22. In yet some other applications, W33 is at least 100 times W22. In yet some other applications, W33 is at least 500 times W22.

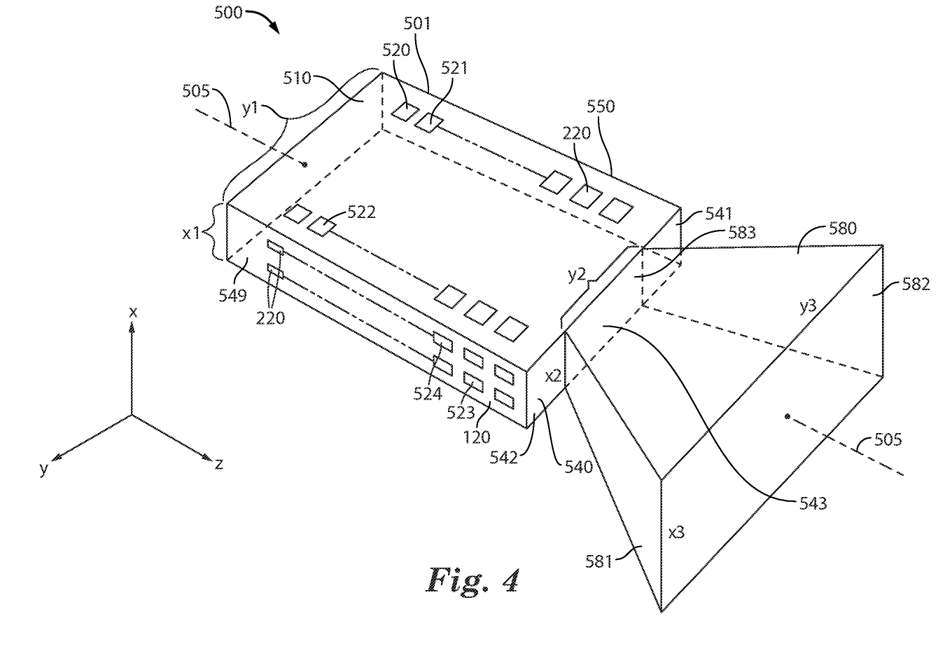

FIG. 4 illustrates a schematic three-dimensional view of a light source assembly 500 in accordance with one embodiment of the invention. Light source assembly 500 is similar to light source assembly 200, and includes a light guide 501, an array 520 of discrete light sources 220, and a light extractor 580.

Light guide 501 is centered on an optical axis 505 parallel to the z-axis and has a rectangular cross-section in the xy-plane having a width y1 along the y-axis and a height x1 along the x-axis. Light guide 501 contains a converting material 120 that, as discussed previously, is capable of emitting light of wavelength λ₂ when illuminated by light of wavelength λ₁ where λ₂ is different from λ₁. In one embodiment of the invention, converting material 120 is uniformly distributed within light guide 501.

Light guide 501 further includes a first end face 510 that is substantially reflective at wavelength λ₂ and a second end face 540 that includes a transmissive portion 543 that is substantially optically transmissive at wavelength λ₂ and which is positioned between two reflective portions 541 and 542, each of which is substantially reflective at λ₂.

Transmissive portion 543 has a rectangular profile with a width y2 along the y-axis and a height x2 equal to x1 along the x-axis. According to one embodiment of the invention, the ratio y2/x2 is about 16/9. In some applications, the ratio y2/x2 may be a different value.

Light guide 501 further includes walls 549 that are substantially transmissive and capable of reflecting light by total internal reflection.

Light extractor 580 is a pyramidal frustum (truncated pyramid) and has an optically transmissive rectangular input face 583 that substantially coincides with transmissive portion 543, an optically transmissive rectangular output face 582 with a width y3 along the y-axis and a height x3 along the x-axis, and walls 581. According to one embodiment of the invention, the ratio y3/x3 is about 16/9. In some applications, the ratio y3/x3 may be a different value.

In the exemplary embodiment shown in FIG. 4, light extractor 580 tapers outwardly along optical axis 505. In some applications, light extractor 580 may taper inwardly.

Light source array 520 includes a two-dimensional light source array of discrete light sources 220 arranged along and proximate the top surface of optical slab 530. In the exemplary embodiment shown in FIG. 4, array 520 includes a two-dimensional regularly-spaced array of discrete light sources 220 arranged in first and second rows 521 and 522, respectively. Each row can include many discrete light sources 220. In some applications, each row includes at least 5 discrete light sources 220. In some other applications, each row includes at least 10 discrete light sources 220. In some other applications, each row includes at least 20 discrete light sources 220. In yet some other applications, each row includes at least 30 discrete light sources 220.

According to one embodiment of the invention, for a given concentration or doping density of converting material 120 in light guide 501, height x1 is large enough so that a substantial portion of light at λ₁ that is emitted by light sources 220 in rows 521 and 522 is absorbed by the light guide.

In general, light sources 220 can be positioned anywhere along light guide 501 where light that is emitted by the light sources can be efficiently absorbed by converting material 120. For example, light sources 220 can be arranged in first and second rows 521 and 522 on the top side (in the yz-plane) of light guide 501. In some applications, light sources 220 can be arranged in the xz-plane adjacent a side of the light guide, such as row 523 of light sources 220 and row 524 of light sources 220. In such a case, the doping density of converting material 120 in light guide 501 and/or width y1 are large enough so that a substantial portion of light at λ₁ that is emitted by light sources 220 in rows 523 and 524 is absorbed by the light guide.

In yet some other applications, some light sources may be arranged along one side of light guide 501 and some other light sources may be positioned along a different side of the light guide.

According to one embodiment of the invention, walls 581 of light extractor 580 are substantially optically transmissive at wavelength λ₂, although, in some applications, walls 581 may be substantially reflective at λ₂. In general, walls 581 may include one or more portions that are substantially transmissive at λ₂ and one or more portions that are substantially reflective at λ₂.

According to one embodiment of the invention, the majority of light rays of wavelength λ₂ that are emitted by converting material 120, and which exit the light guide through transmissive portion 543, undergo at least one total internal reflection within light guide 501.

Light guide 501 has an exterior surface 550 having a total first area W1. Exterior surface 550 includes an optically reflective portion that includes, for example, end face 510 and reflective portions 541 and 542, and which has a total second area W2. Exterior surface 550 further includes an optically transmissive portion that includes, for example, transmissive portion 543, and which has a total third area W3 where W1=W2+W3. According to one embodiment of the invention, W3 is substantially larger than W2.

In some applications, W3 is at least 5 times W2. In some other applications, W3 is at least 10 times W2. In some other applications, W3 is at least 20 times W2. In some other applications, W3 is at least 50 times W2. In some other applications, W3 is at least 75 times W2. In yet some other applications, W3 is at least 100 times W2. In yet some other applications, W3 is at least 500 times W2.

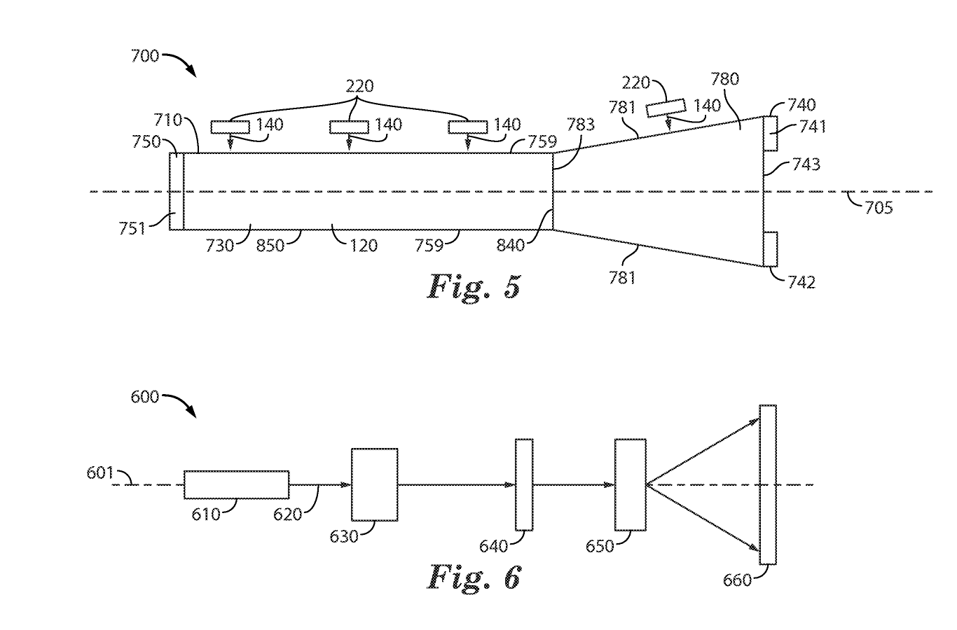

FIG. 5 illustrates a schematic side-view of a light source assembly 700 in accordance with one embodiment of the invention. Light source assembly 700 includes a light guide 710 generally centered on optical axis 705, and one or more light sources 220. Light guide 710 includes an optical rod 730 which joins an end face 750 to an optically transmissive exit face 840. Optical rod 730 has walls 850 and contains converting material 120 that is capable of emitting light of wavelength λ₂ when illuminated with light of wavelength λ₁. End face 750 includes a reflective film 751, similar to reflective film 251, that covers essentially the entire end face 750, although in some applications, reflective film 751 may cover only a portion of end face 750.

Light guide 710 further includes a light expander 780 that has an optically transmissive input face 783, an output face 740 and walls 781. According to one embodiment of the invention, input face 783 and exit face 840 match, meaning that the two have the same shape and size and substantially overlap. In some applications, however, input face 783 and exit face 840 may not match. For example, they may have different sizes, different shapes, or they may not fully overlap. Light expander 780 may or may not include converting material 120.

Output face 740 includes an optically transmissive portion 743 and optically reflective portions 741 and 742. In general, output face 740 may include one or more transmissive portions and one or more reflective portions. Exemplary embodiments of output face 740 are shown in FIGS. 2A-2E where transmissive portion 743 is similar to transmissive portion 132, reflective portions 741 and 742 are similar to reflective portion 131, and optical axis 705 is similar to optical axis 105.

Light source assembly 700 further includes one or more light sources 220 capable of generating light 140 of wavelength λ₁. Light sources 220 are generally positioned along walls 850 and are designed to directly illuminate optical rod 730 with light of wavelength λ₁. In some applications, one or more light sources 220 may also be arranged along and in close proximity to walls 781 for direct illumination of light extractor 780 with light of wavelength λ₁, as shown in FIG. 5. Such an arrangement may be particularly desirable where light extractor 780 contains converting material 120.

Reflective portions 741 and 742 and reflective film 751 provide a recycling cavity so that light rays at wavelength λ₂ that are generated within light guide 710 and which do not exit the light guide from transmissive portion 743 are recycled within the light guide until all or a substantial portion of the recycled light rays eventually exit the light guide from transmissive portion 743.

According to one embodiment of the invention, the majority of light rays of wavelength λ₂ that are emitted by converting material 120 and which exit light guide 710 through transmissive portion 743, undergo one or more total internal reflections by exterior surface 759 of the light guide before exiting the light guide.

According to one embodiment of the invention, exterior surface 759 of light guide 710 has an optically transmissive portion with a first area. In the exemplary embodiment shown in FIG. 5, the optically transmissive portion of exterior surface 759 includes, for example, walls 850 of optical rod 730 and optically transmissive portion 743 of light expander 780. In general, the optically transmissive portion of exterior surface 759 may include additional transmissive portions not explicitly shown in FIG. 5. Furthermore, exterior surface 759 of light guide 710 has an optically reflective portion with a second area. In the exemplary embodiment shown in FIG. 5, the optically reflective portion of exterior surface 759 includes, for example, reflective film 751 and reflective portions 741 and 742, although in general, there could be other reflective portions that are included in the optically reflective portion of exterior surface 759 and which are not explicitly shown in FIG. 5.

According to one embodiment of the invention, the first area of exterior surface 759 is substantially larger than the second area of the exterior surface. In some applications, the first area is at least 5 times the second area. In some other applications, the first area is at least 10 times the second area. In some other applications, the first area is at least 20 times the second area. In some other applications, the first area is at least 50 times the second area. In some other applications, the first area is at least 75 times the second area. In yet some other applications, the first area is at least 100 times the second area. In yet some other applications, the first area is at least 500 times the second area.

Light expander 780 may be a component separate from optical rod 730, as illustrated in FIG. 5, in which case, exit face 840 and input face 783 may be optically coupled by, for example, adhering the two by an optical adhesive or by simply placing the two in close proximity to one another. According to one embodiment of the invention, light expander 780 is an integral part of optical rod 730. For example, optical rod 730 and light expander 780 may be molded from a single piece of material, such as glass or a polymeric material, in which case, the interface between faces 840 and 783 may be absent and the light expander may contain converting material 120. In such a case, both the optical rod and the light expander may be directly illuminated with light sources 220, although in some applications, it may be sufficient or desirable to only illuminate the optical rod with light sources 220.

FIG. 6 illustrates a schematic side-view of a projection display system 600 in accordance with one embodiment of the invention. Projection display system 600 is generally centered on an optical axis 601 and includes a light source assembly 610, relay optics 630, an image forming device 640, projection optics 650, and a projection screen 660.

Light source assembly 610 can be a light source assembly in accordance with any embodiment of the present invention. Light source assembly 610 includes a light guide in accordance with any embodiment of the present invention. The light source assembly is capable of generating output light 620 at, for example, wavelength λ₂. Output light 620 is used by relay optics 630 to illuminate an image forming device 640 that is capable of forming an image for projection onto screen 660.

Image forming device 640 may be a liquid crystal display (LCD) where the LCD can be a transmissive LCD such as a high temperature polysilicon (HTPS) or a reflective LCD such as a liquid crystal on silicon (LCoS). Other exemplary image forming devices include a switchable mirror display or a micro-electromechanical system (MEMS), such as a digital micromirror device (DMD) from Texas Instruments or a grating light valve (GLV) discussed, for example, in U.S. Pat. No. 5,841,579. In general, image forming device 640 can be any device, including any switchable device, capable of forming an image.

An image formed by image forming device 640 is magnified and projected by projection optics 650 onto screen 660 for viewing. Projection optics 650 typically includes one or more optical lenses.

The layout in FIG. 6 shows an unfolded projection display system 600, meaning that optical axis 601 is a straight line, not folded at any point along the optical axis. To economize space, projection display system 600 may be folded at one or more points along optical axis 601.

The exemplary projection display system 600 in FIG. 6 shows one light source assembly 610 and one optically transmissive image forming device 640. In general, projection display system 600 can have one or more light source assemblies and one or more reflective or transmissive image forming device, in which case, each light source assembly can have a dedicated relay optics.

Projection display system 600 may be a rear projection system, in which case, projection screen 660 is preferably a rear projection screen. Projection display system 600 may be a front projection system, in which case, projection screen 660 is preferably a front projection screen.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A light guide comprising:
a material capable of emitting light of a second wavelength when illuminated with light of a first wavelength different from the second wavelength; and
an exit face having a first portion reflective at the second wavelength and a second portion transmissive at the second wavelength,
such that when the light guide is illuminated with light of the first wavelength, the material converts at least a portion of the light of the first wavelength into light of the second wavelength, wherein the majority of the light of the second wavelength that exits the second portion of the exit face is totally internally reflected by the light guide.

2. The light guide of claim 1, wherein the second portion is at least partially surrounded by the first portion.

3. The light guide of claim 1, wherein the first portion is at least 80% reflective at the second wavelength.

4. The light guide of claim 1, wherein the second portion is at least 80% transmissive at the second wavelength.

5. The light guide of claim 1, wherein the material is dispersed throughout the entire light guide.

6. The light guide of claim 1, wherein the first and second wavelengths are in the UV and visible regions of the electromagnetic spectrum, respectively.

7. The light guide of claim 1, wherein the first and second wavelengths are in the blue and green regions of the electromagnetic spectrum, respectively.

8. The light guide of claim 1, wherein the first and second wavelengths are in the blue and red regions of the electromagnetic spectrum, respectively.

9. The light guide of claim 1 further comprising a tapered light extractor disposed proximate the exit face.

10. The light guide of claim 1, wherein the material comprises a fluorescent material.

11. The light guide of claim 1, wherein the material comprises a phosphorescent material.

12. A projection display system comprising the light guide of claim 1.

13. A light guide comprising:
a material capable of emitting light of a second wavelength when illuminated by light of a first wavelength different from the second wavelength; and
an exterior surface that includes an exit face, the exit face having a first portion reflective at the second wavelength and a second portion transmissive at the second wavelength, the exterior surface having an optically transmissive portion having a first area and an optically reflective portion having a second area, the first area being substantially larger than the second area,
wherein illumination of the transmissive portion of the exterior surface with light of the first wavelength causes the material to convert at least a portion of the light of the first wavelength into light of the second wavelength, at least a portion of the light of the second wavelength exiting the transmissive portion of the exit face.

14. The light guide of claim 13, wherein the majority of the light of the second wavelength that exits the light guide from the transmissive portion of the exit face is totally internally reflected by the transmissive portion of the exterior surface before exiting the transmissive portion of the exit face.

15. The light guide of claim 13, wherein the first area is at least 10 times the second area.

16. The light guide of claim 13, wherein the first area is at least 50 times the second area.

17. The light guide of claim 13, wherein the first area is at least 100 times the second area.

18. A projection display system comprising the light guide of claim 13.

19. A light source assembly comprising at least one light source and the light guide of claim 13, the at least one light source being capable of illuminating the transmissive portion of the exterior surface with light of the first wavelength.
